(19) United States
(12) Patent Application Publication
(10) Pub. No.: US 2021/0291621 A1
(43) Pub. Date: Sep. 23, 2021

(54) CONTROL VALVE

(71) Applicant: YAMADA MANUFACTURING CO., LTD., Kiryu-shi (JP)

(72) Inventor: Akifumi Ozeki, Kiryu-shi (JP)

(21) Appl. No.: 17/190,181

(22) Filed: Mar. 2, 2021

(30) Foreign Application Priority Data
Mar. 19, 2020 (JP) 2020-050173
Dec. 11, 2020 (JP) 2020-205831

(51) Int. Cl. B60H 1/00; F01P 7/16

(52) U.S. Cl. CPC B60H 1/00885; F01P 2007/146; B60H 2001/00307; F01P 7/165

(57) ABSTRACT

A control valve includes a casing, a valve body, a seal cylindrical member, and a drive shaft. The casing includes an inlet and an outlet. The valve body includes a valve hole formed close to one end portion of a circumferential wall part in an axial direction. The seal cylindrical member communicates with the outlet and is in contact with an outer circumferential surface of the circumferential wall part to be opened and closed by the valve hole. The valve body includes the circumferential wall part and a connecting wall which connects a position close to one end portion of the circumferential wall part in the axial direction and the drive shaft. The connecting wall extends radially inward from an axially inner position of the circumferential wall part with respect to an end edge close to one end portion of the valve hole to form a recess-shaped part that opens to one end portion side of the circumferential wall part in the axial direction. An end portion wall on one end portion side of the casing in the axial direction bulges to enter the inside of the recess-shaped part.

### CROSS-REFERENCE TO RELATED APPLICATION

Priority is claimed on Japanese Patent Application No. 2020-050173 filed in Japan on Mar. 19, 2020 and Japanese Patent Application No. 2020-205831 filed in Japan on Dec. 11, 2020, the contents of which are incorporated herein by reference.

### BACKGROUND OF THE INVENTION

### Field of the Invention

The present invention relates to a control valve used for switching of a flow path of cooling water for a vehicle.

### Description of Related Art

In cooling systems that cool engines using cooling water, there are cases in which a bypass flow path that bypasses a radiator, an air conditioning flow path that heats air conditioning air, and the like are provided in combination in addition to a radiator flow path for circulation between the radiator and the engine. In this type of cooling system, a control valve is interposed at a branch part of flow paths so that the flow paths are switched by the control valve as appropriate. As a control valve, one in which a valve body having a circumferential wall part (cylindrical wall) is rotatably disposed in a casing and an arbitrary flow path is opened or closed according to a rotational position of the valve body is known (see, for example, Japanese Unexamined Patent Application, First Publication No. 2015-96736 (hereinafter referred to as Patent Document 1)).

In the control valve described in Patent Document 1, an inlet into which a liquid, such as a cooling liquid, flows and a set number of outlets for discharging the liquid that has flowed in to the outside are provided in a casing. In the circumferential wall part of the valve body, a plurality of valve holes that allow the inside and outside to communicate are formed to correspond to a plurality of outlets. One end portion side of a seal cylindrical member having a cylindrical shape is held at each of the outlets of the casing. A valve sliding contact surface that is slidably in contact with an outer circumferential surface of the circumferential wall part of the valve body is provided at the other end portion side of each seal cylindrical member. The valve sliding contact surface of each seal cylindrical member is in sliding contact with the outer circumferential surface of the circumferential wall part at a position at which it overlaps a rotation path of a corresponding valve hole of the valve body. Each seal cylindrical member is opened or closed by the corresponding valve hole in the valve body.

The valve body allows an outflow of the liquid from an inner region of the circumferential wall part to a corresponding outlet when the seal cylindrical member is at a rotational position at which it communicates with the corresponding valve hole and shuts off an outflow of the liquid from the inner region of the circumferential wall part to a corresponding outlet when the seal cylindrical member is at a rotational position at which it does not communicate with the corresponding valve hole. The rotational position of the valve body is operated using actuators such as an electric motor.

A drive shaft for transmitting power of the actuator to the valve body is disposed at an axial center position of the circumferential wall part of the valve body. A connecting wall for connecting the circumferential wall part and the drive shaft is integrally formed at one end portion in the axial direction of the circumferential wall part of the valve body. The connecting wall extends radially inward from one end portion of the circumferential wall part in the axial direction, and an end portion on a radially inner side of the connecting wall is connected to the drive shaft. An end portion wall on one end side (actuator side) of the casing in the axial direction is disposed adjacent to an outer side in the axial direction of the connecting wall.

### SUMMARY OF THE INVENTION

However, in the control valve described in Patent Document 1, since the connecting wall connecting the circumferential wall part of the valve body and the drive shaft extends radially inward from one end portion of the circumferential wall in the axial direction, an end portion on a radially outer side of the connecting wall becomes an obstacle, and the end portion wall of the casing cannot be allowed to sufficiently enter the circumferential wall part in an axially inner direction. Therefore, an inflow volume of a liquid inside the circumferential wall part of the valve body increases, and an amount of the liquid flowing through a liquid distribution system (for example, the cooling system described above) including the control valve increases. When an amount of liquid flowing through the liquid distribution system increases, it takes a long time to control each part in the liquid distribution system to have a desired temperature, and friction of the engine serving as a drive source increases.

Aspects according to the present invention have been made in view of the above-described problems, and it is an objective of the present invention to provide a control valve capable of controlling each part in the liquid distribution system to have a desired temperature quickly by making it possible to reduce an inflow volume of the cooling liquid inside the circumferential wall part of the valve body.

In order to solve the above-described problems and achieve the objective, the present invention employs the following aspects.

(1) A control valve of one aspect according to the present invention includes a casing including an inlet into which a liquid flows from the outside and an outlet through which the liquid that has flowed into the inside is allowed to flow out to the outside, a valve body rotatably disposed inside the casing and including a valve hole formed close to one end portion of a circumferential wall part in an axial direction, a seal cylindrical member including one end portion which communicates with the outlet and the other end portion which is in contact with an outer circumferential surface of the circumferential wall part to be opened and closed by the valve hole, and a drive shaft disposed at an axial center position of the valve body and configured to transmit rotational power to the valve body, in which the valve body includes the circumferential wall part and a connecting wall which connects a position close to the one end portion of the circumferential wall part in the axial direction and the drive shaft, the connecting wall extends radially inward from an axially inner position of the circumferential wall part with respect to an end edge close to the one end portion of the valve hole to form a recess-shaped part that opens to the one end portion side of the circumferential wall part in the axial direction, and an end portion wall close to one end portion of the casing in the axial direction bulges to enter the inside of the recess-shaped part.

According to the above-described aspect (1), since an outer circumferential edge portion of the connecting wall of the valve body is disposed to be largely recessed inward in the axial direction from the end portion close to one end portion of the circumferential wall part, a bulging portion of the end portion wall close to one end portion of the casing in the axial direction can be allowed to largely enter the inside of the recess-shaped part. As a result, an inflow volume of the liquid flowing into the inside of the circumferential wall part of the valve body can be made to be small.

(2) In the above-described aspect (1), an end portion on a radially outer side of the connecting wall may be connected to the end edge close to the one end portion of the valve hole via a connecting part that is recessed radially inward with respect to the outer circumferential surface of the circumferential wall part.

According to the above-described aspect (2), the connecting wall is connected to the end edge of the valve hole by the connecting part even at a position in a circumferential direction at which the valve hole is present. Therefore, when the present configuration is employed, rigidity of a joint part of the connecting wall with respect to the circumferential wall part can be increased.

(3) In the above-described aspect (2), the seal cylindrical member may include an annular valve sliding contact surface that is slidably in contact with the outer circumferential surface of the circumferential wall part, and the end edge close to the one end portion of the valve hole and an end edge close to the other end portion facing the end edge may be in contact with a radially outer position with respect to an inner circumferential end portion of the valve sliding contact surface of the seal cylindrical member.

According to the above-described aspect (3), the end edge close to the one end portion of the valve hole and an end edge close to the other end portion are in sliding contact with the valve sliding contact surface at a radially outer position with respect to the inner circumferential end portion of the valve sliding contact surface of the seal cylindrical member. Therefore, even when abrasion occurs on the valve sliding contact surface of the seal cylindrical member due to use over time, the abraded portion does not stretch across the inner circumferential end portion of the seal cylindrical member. Accordingly, even when the above-described abrasion occurs on the valve sliding contact surface, leakage of the liquid to the inside of the seal cylindrical member through a gap between the circumferential wall part and the valve sliding contact surface can be suppressed.

(4) In any one of the above-described aspects (1) to (3), it is desirable that the connecting wall close a space between the circumferential wall part and the drive shaft.

According to the above-described aspect (4), since the liquid that has flowed into the circumferential wall part does not easily flow out to the outer side in the axial direction of the circumferential wall part with respect to the connecting wall, a pressure loss of the liquid due to the liquid flowing into an unnecessary portion can be suppressed.

(5) In the above-described aspect (4), the connecting wall may have a shape that is curved inward in the axial direction of the circumferential wall part from the end portion on the radially outer side toward the radially inner side.

According to the above-described aspect (5), the liquid that has flowed into the circumferential wall part is guided by a curved surface of the connecting wall and flows smoothly in a direction of the valve hole.

(6) In any one of the above-described aspects (1) to (5), the valve hole may be formed in a long hole shape extending in a circumferential direction of the circumferential wall part.

According to the above-described aspect (6), since the valve hole has a long hole shape extending in the circumferential direction, even when a part of the valve hole is narrowed by the connecting wall, a sufficient area of the inflow portion of the liquid can be secured by the long hole shape extending in the circumferential direction.

According to the aspects according to the present invention, the connecting wall of the valve body extends radially inward from an axially inner position of the circumferential wall part with respect to the end edge close to one end portion of the valve hole, the connecting wall forms the recess-shaped part on one end portion side of the circumferential wall part in the axial direction, and the end portion wall of the casing has a shape that enters the recess-shaped part. Therefore, an inflow volume of the liquid flowing into the circumferential wall part of the valve body can be reduced by the end portion wall of the casing, and each part of the liquid distribution system can be quickly controlled to have a desired temperature.

### BRIEF DESCRIPTION OF THE DRAWINGS

FIG. 1 is a block diagram of a liquid distribution system of an embodiment.

FIG. 2 is a perspective view of a control valve of the embodiment.

FIG. 3 is an exploded perspective view of the control valve of the embodiment.

FIG. 4 is a cross-sectional view of the control valve of the embodiment along line IV-IV of FIG. 2.

FIG. 5 is a cross-sectional view of the control valve of the embodiment along line V-V of FIG. 4.

FIG. 6 is an enlarged view of the VI portion of FIG. 5.

FIG. 7 is a cross-sectional view of the control valve of the embodiment along line VII-VII of FIG. 2.

FIG. 8 is a perspective view illustrating a valve body and a seal cylindrical member of the embodiment.

FIG. 9 is a longitudinal sectional view of the seal cylindrical member of the embodiment.

FIG. 10 is a cross-sectional view of another embodiment similar to FIG. 7.

### DETAILED DESCRIPTION OF THE INVENTION

Next, an embodiment of the present invention will be described with reference to the drawings. In the present embodiment, a control valve is employed in a liquid distribution system of a vehicle that distributes and supplies a cooling liquid for cooling an engine to a radiator and other devices.

### [Liquid Distribution System]

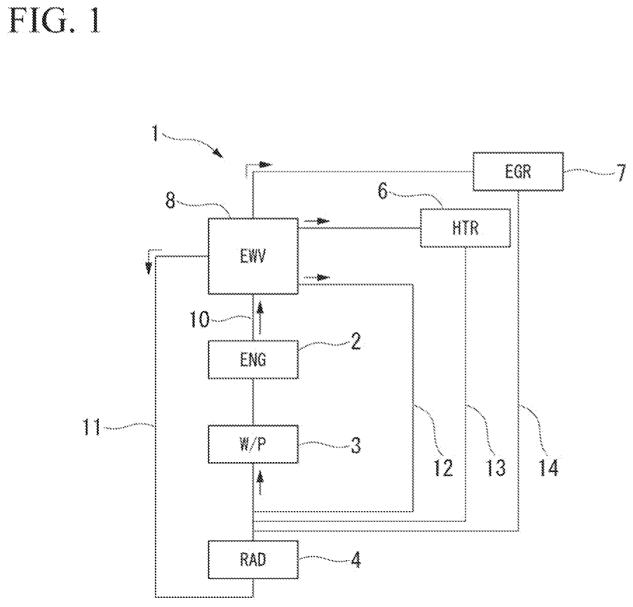

FIG. 1 is a block diagram of a liquid distribution system 1.

As illustrated in FIG. 1, the liquid distribution system 1 is mounted in a vehicle in which at least an engine is included as a vehicle drive source. As a vehicle, a hybrid vehicle, a plug-in hybrid vehicle, or the like may be included in addition to a vehicle having only an engine.

The liquid distribution system 1 is configured such that an engine 2 (ENG), a water pump 3 (W/P), a radiator 4 (RAD), a heater core 6 (HTR), an EGR cooler 7 (EGR), and a control valve 8 (EWV) are connected by various flow paths 10 to 14.

The water pump 3, the engine 2, and the control valve 8 are connected in order from upstream to downstream on a main flow path 10. In the main flow path 10, a cooling liquid (liquid) passes through the engine 2 and the control valve 8 in order due to the operation of the water pump 3.

A radiator flow path 11, a bypass flow path 12, an air conditioning flow path 13, and an EGR flow path 14 are each connected to the main flow path 10. The radiator flow path 11, the bypass flow path 12, the air conditioning flow path 13, and the EGR flow path 14 connect an upstream portion of the water pump 3 in the main flow path 10 and the control valve 8.

The radiator 4 is connected to the radiator flow path 11. In the radiator flow path 11, heat exchange between the cooling liquid and outside air is performed in the radiator 4. The bypass flow path 12 allows the cooling liquid that has passed through the control valve 8 to bypass the radiator 4 (the radiator flow path 11) and return to the upstream portion of the water pump 3.

The heater core 6 is connected to the air conditioning flow path 13. The heater core 6 may be provided, for example, in a duct (not illustrated) of an air conditioner. In the air conditioning flow path 13, heat exchange between the cooling liquid and air conditioning air flowing in the duct is performed in the heater core 6.

The EGR cooler 7 is connected to the EGR flow path 14. In the EGR flow path 14, heat exchange between the cooling liquid and an EGR gas is performed in the EGR cooler 7.

In the liquid distribution system 1 described above, the cooling liquid which has passed through the engine 2 in the main flow path 10 flows into the control valve 8 and then is selectively distributed to the various flow paths 11 to 13 by the operation of the control valve 8.

### [Control Valve]

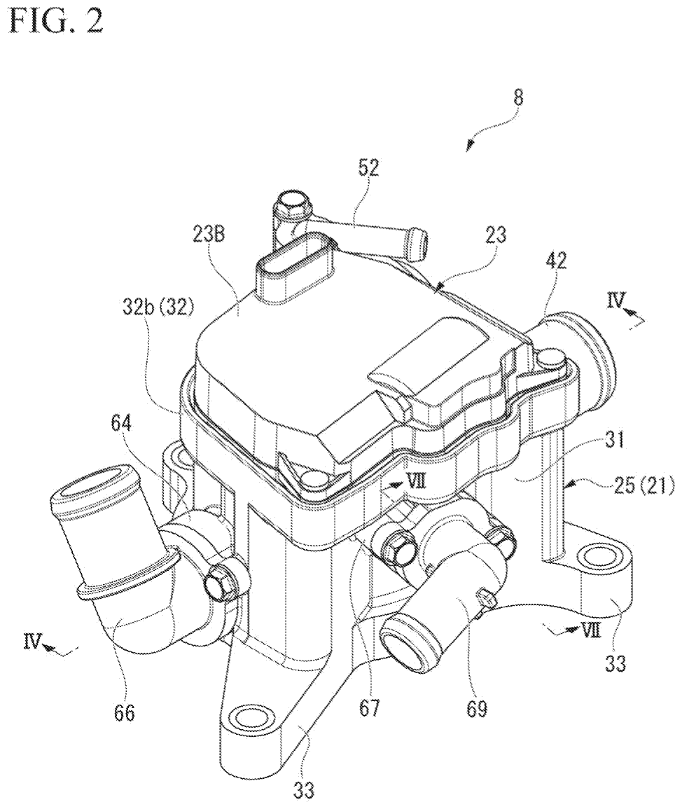

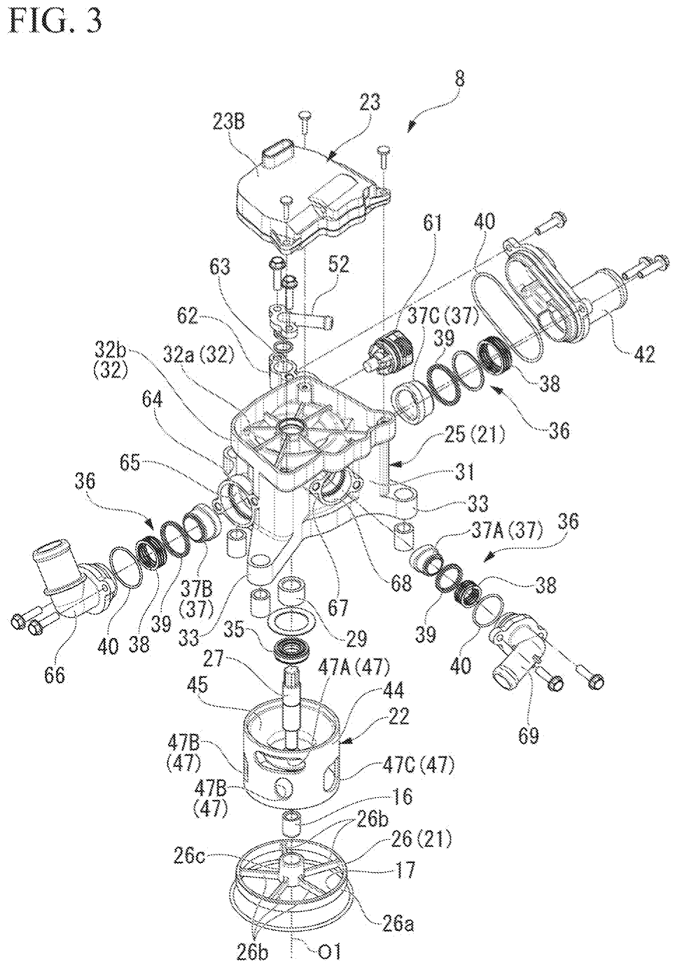

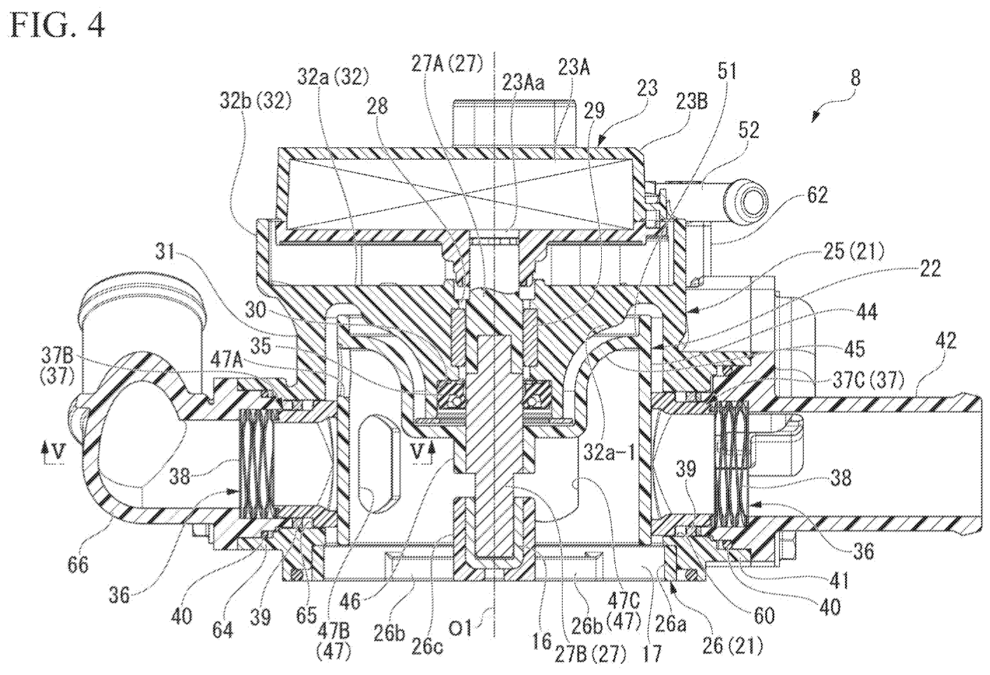

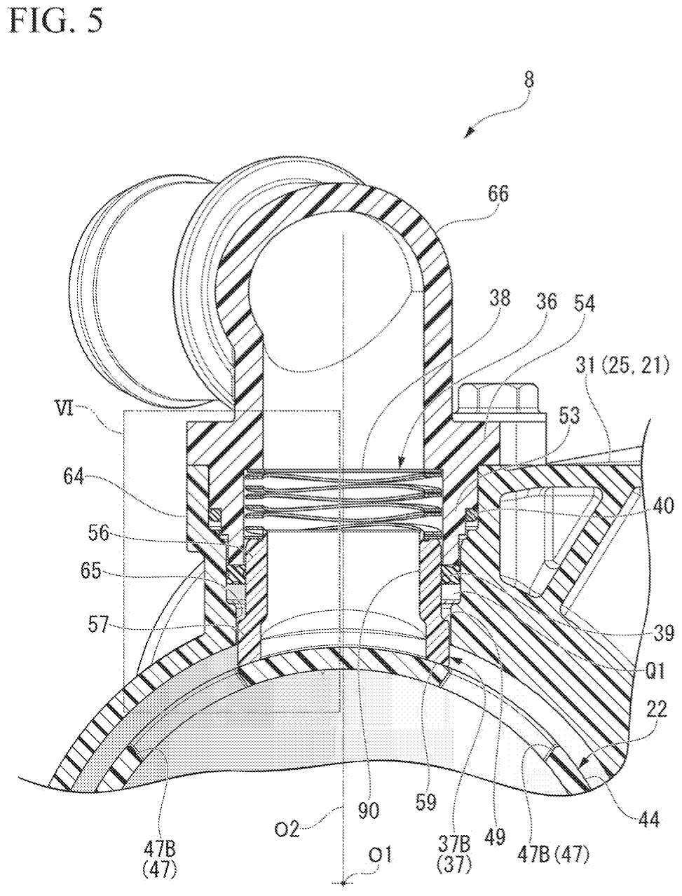

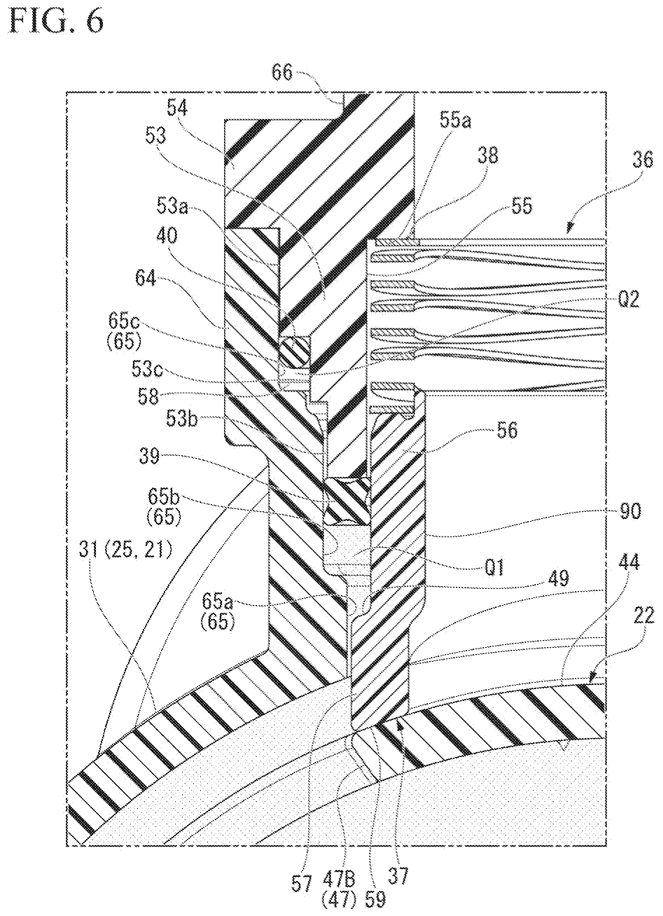

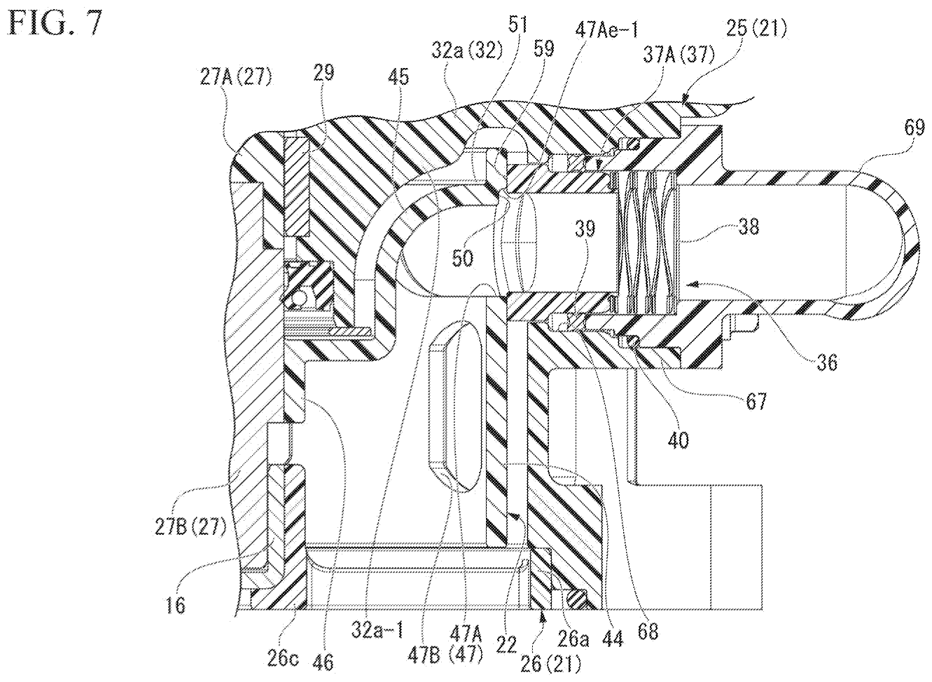

FIG. 2 is a perspective view of the control valve 8, and FIG. 3 is an exploded perspective view of the control valve 8. FIG. 4 is a cross-sectional view of the control valve 8 along line IV-IV of FIG. 2, and FIG. 5 is a cross-sectional view of the control valve 8 along line V-V of FIG. 4. FIG. 6 is an enlarged view of the VI portion of FIG. 5, and FIG. 7 is a cross-sectional view of the control valve 8 along line VII-VII of FIG. 2.

As illustrated in these figures, the control valve 8 mainly includes a casing 21, a valve body 22, and a drive unit 23.

### [Casing]

The casing 21 includes a bottomed cylindrical casing main body 25 and an end portion cover 26 attached to an end portion of the casing main body 25 on an opening side. The valve body 22 is rotatably accommodated inside the casing 21. An axis of the casing 21 that matches a rotation central axis of the valve body 22 is referred to as an axis O1 of the casing 21. In the following description, a direction along the axis O1 of the casing 21 is simply referred to as a case axial direction. In the case axial direction, a side toward an end portion wall 32, which is a bottom wall of the casing main body 25, with respect to a case circumferential wall 31 of the casing main body 25 is referred to as one end side in the case axial direction, and a side toward the end portion cover 26 with respect to the case circumferential wall 31 of the casing main body 25 is referred to as the other end side in the case axial direction. Further, a direction perpendicular to the axis O1 of the casing 21 is referred to as a case radial direction.

An outer surface shape of the casing main body 25 is formed in a substantially rectangular parallelepiped shape using a resin material. A plurality of mounting pieces 33 are provided to extend at an end portion of the case circumferential wall 31 on the other end side in the case axial direction. The control valve 8 is fixed to an engine block or the like (not illustrated) via the mounting pieces 33.

In the end portion cover 26 of the casing 21, a boss part 26c is disposed at an axial center position of an annular frame case 26a. The boss part 26c is supported by the frame case 26a using a plurality of spoke parts 26b. A bottomed cylindrical slide bearing 16 is attached to the boss part 26c. An opening portion of the end portion cover 26 surrounded by the frame case 26a, the boss part 26c, and the spoke parts 26b adjacent to each other is an inlet 17 that allows the cooling liquid to flow into the inside of the casing 21. The inlet 17 is connected to a downstream side of the engine 2 of the main flow path 10 (see FIG. 1) of the liquid distribution system 1. The end portion cover 26 is formed of a resin material like the casing main body 25.

A radiator port 41 (see FIG. 4) that bulges outward in the case radial direction is formed on a wall forming one surface of the case circumferential wall 31. In the radiator port 41, a fail opening (not illustrated) and a radiator outlet 60 (outlet) are formed to be aligned in a direction perpendicular to the case axial direction. The radiator outlet 60 is formed to pass through the radiator port 41. The fail opening and the radiator outlet 60 are formed at a position biased toward the other end side in the case axial direction of the wall forming one surface of the case circumferential wall 31.

A radiator joint 42 is connected to an opening end surface of the radiator port 41. The radiator joint 42 connects the radiator outlet 60 and an upstream end portion of the radiator flow path 11 (see FIG. 1).

A sealing mechanism 36 is provided in the radiator outlet 60. The sealing mechanism 36 includes a seal cylindrical member 37, a biasing member 38, and seal members 39 and 40. One end portion of the seal cylindrical member 37 in the axial direction communicates with the inside of the radiator outlet 60 (downstream side of the radiator outlet 60), and the other end portion thereof in the axial direction is opened and closed by the valve body 22 to be described below. The sealing mechanism 36 will be described in detail below.

A thermostat 61 is disposed in the fail opening. The thermostat 61 opens and closes the fail opening according to a temperature of the cooling liquid flowing in the casing 21. The fail opening communicates with the radiator joint 42 (the radiator flow path 11). When a temperature of the cooling liquid flowing in the casing 21 rises higher than a specified temperature, the thermostat 61 opens the fail opening to allow the cooling liquid in the casing 21 to flow out to the radiator flow path 11.

In the vicinity of an end portion on one end side of the case circumferential wall 31 in the case axial direction, an EGR port 62 is formed adjacent to an accommodating part of the thermostat 61. The EGR port 62 is formed on the case circumferential wall 31 to bulge outward in the case radial direction. An EGR outlet 63 communicating with a portion on an upstream side of the thermostat 61 in the accommodation part of the thermostat 61 is formed in the EGR port 62. An EGR joint 52 is connected to an opening end surface of the EGR port 62. The EGR joint 52 connects the EGR outlet 63 and an upstream end portion of the EGR flow path 14 (see FIG. 1).

A bypass port 64 that bulges outward in the case radial direction is formed on a wall of the case circumferential wall 31 on a side facing the wall on which the radiator port 41 is formed. A bypass outlet 65 (outlet) that passes through the bypass port 64 in the case radial direction is formed in the bypass port 64. The bypass outlet 65 is formed at a position facing the radiator outlet 60 with the axis O1 of the casing 21 interposed therebetween. The bypass outlet 65 is formed at a position biased toward the other end side of the case circumferential wall 31 in the case axial direction like the radiator outlet 60.

A bypass joint 66 is connected to an opening end surface of the bypass port 64. The bypass joint 66 connects the bypass outlet 65 and an upstream end portion of the bypass flow path 12 (see FIG. 1). A sealing mechanism 36 similar to that provided in the radiator outlet 60 is provided in the bypass outlet 65. One end portion of a seal cylindrical member 37 of the sealing mechanism 36 in the axial direction communicates with the inside of the bypass outlet 65 (downstream side of the bypass outlet 65), and the other end portion thereof in the axial direction is opened and closed by the valve body 22.

An air conditioning port 67 (see FIGS. 2 and 3) that bulges outward in the case radial direction is formed on a wall of the case circumferential wall 31 adjacent to one side of the wall on which the radiator port 41 is formed. An air conditioning outlet 68 that passes through the air conditioning port 67 in the case radial direction is formed in the air conditioning port 67. An air conditioning joint 69 is connected to an opening end surface of the air conditioning port 67. The air conditioning joint 69 connects the air conditioning outlet 68 and an upstream end portion of the air conditioning flow path 13 (see FIG. 1). A sealing mechanism 36 similar to that provided in the radiator outlet 60 and the bypass outlet 65 is provided in the air conditioning outlet 68. One end portion of a seal cylindrical member 37 of the sealing mechanism 36 in the axial direction communicates with the inside of the air conditioning outlet 68 (downstream side of the air conditioning outlet 68), and the other end portion thereof in the axial direction is opened and closed by the valve body 22.

In the following description, the seal cylindrical member 37 communicating with the inside of the air conditioning outlet 68 may be referred to as a first seal cylindrical member 37A, the seal cylindrical member 37 communicating with the inside of the bypass outlet 65 may be referred to as a second seal cylindrical member 37B, and the seal cylindrical member 37 communicating with the inside of the radiator outlet 60 may be referred to as a third seal cylindrical member 37C.

### [Drive Unit]

The drive unit 23 is attached to the end portion wall 32 of the casing main body 25. As illustrated in FIG. 4, the end portion wall 32 includes an end portion wall main body 32a that closes an end surface of the case circumferential wall 31 on one end side in the case axial direction, and a surrounding wall 32b that protrudes from an outer circumferential edge portion of the end portion wall main body 32a to one end side in the case axial direction. A part of the drive unit 23 is accommodated inside the surrounding wall 32b and is fixed to the end portion wall 32 by bolt fastening or the like in that state.

The drive unit 23 includes a unit main body 23A constituted by a motor, a speed reduction mechanism, a control board, and the like, and a unit case 23B that accommodates the unit main body 23A. An output shaft 23Aa of the unit main body 23A penetrates the unit case 23B and protrudes to the outside. A separate drive shaft 27 is integrally connected to the output shaft 23Aa. The drive shaft 27 is constituted by a first shaft 27A made of a resin and a second shaft 27B made of a metal which are coaxially connected. The drive shaft 27 passes through a shaft hole 28 formed in the end portion wall main body 32a of the casing 21 and is connected to a shaft center portion of the valve body 22 to be described below. The drive shaft 27 is disposed coaxially with the axis O1 of the casing 21.

A thickness of the end portion wall main body 32a of the casing 21 on a side facing the inside of the case circumferential wall 31 increases from a circumferential edge portion toward a central region (a region at which the shaft hole 28 is formed). That is, a bulging part 32a-1 that bulges in a direction toward the inside of a circumferential wall part 44 of the valve body 22 is formed on a side of the end portion wall main body 32a facing the inside of the case circumferential wall 31. The shaft hole 28 is formed to penetrate a thickest portion of the end portion wall main body 32a in the case axial direction. A cylindrical slide bearing 29 for slidably supporting an outer circumferential surface of the drive shaft 27 (the first shaft 27A) is held inside the shaft hole 28. An enlarged diameter groove 30 having an inner diameter larger than that of an inner circumferential surface of the other portion of the shaft hole 28 is formed at an end edge of the shaft hole 28 on the valve body 22 side. A seal ring 35 that is slidably in close contact with the outer circumferential surface of the drive shaft 27 (the second shaft 27B) to prevent leakage of the cooling liquid from the inside of the casing main body 25 to the drive unit 23 side is attached inside the enlarged diameter groove 30. A portion on the other end side of the second shaft 27B of the drive shaft 27 in the case axial direction is rotatably supported by the boss part 26c of the end portion cover 26 via the slide bearing 16.

### [Valve Body]

The valve body 22 is rotatably disposed inside the casing 21. The valve body 22 includes the cylindrical circumferential wall part 44, a connecting wall 45 provided to extend radially inward from a position close to one end portion of the circumferential wall part 44 in the case axial direction, and a connecting cylindrical part 46 having a substantially cylindrical shape provided to be connected to an end portion of the connecting wall 45 on the radially inner side. The circumferential wall part 44, the connecting wall 45, and the connecting cylindrical part 46 are integrally formed of a resin material. The connecting cylindrical part 46 is integrally connected to the drive shaft 27 (the second shaft 27B). A valve hole 47 that can communicate with each of the above-described outlets (the air conditioning outlet 68, the bypass outlet 65, and the radiator outlet 60) is formed in the circumferential wall part 44. Each valve hole 47 penetrates the circumferential wall part 44 in the case radial direction.

Hereinafter, the valve hole 47 that can communicate with the air conditioning outlet 68 is referred to as a first valve hole 47A, the valve hole 47 that can communicate with the bypass outlet 65 is referred to as a second valve hole 47B, and the valve hole 47 that can communicate with the radiator outlet 60 is referred to as a third valve hole 47C.

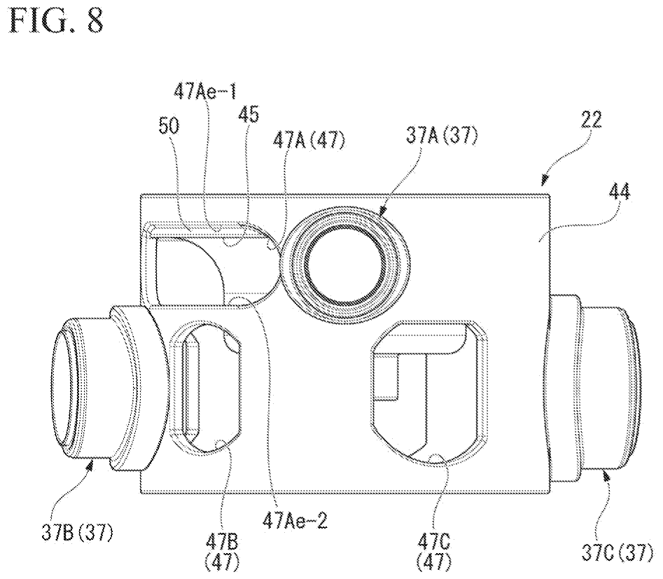

FIG. 8 is a perspective view illustrating the valve body 22 and each seal cylindrical member 37 (the first seal cylindrical member 37A, the second seal cylindrical member 37B, and the third seal cylindrical member 37C) disposed in a circumferential region of the circumferential wall part 44 of the valve body 22.

One first valve hole 47A is formed at a region on one end side of the circumferential wall part 44 in the case axial direction (close to one end portion of the circumferential wall part 44 in the axial direction). The first valve hole 47A is formed in a long hole shape in a circumferential direction of the circumferential wall part 44. The first valve hole 47A allows communication between an internal space of the circumferential wall part 44 of the valve body 22 and the air conditioning outlet 68 when the valve body 22 is in a predetermined rotation range. A width of the first valve hole 47A in the axial direction of the circumferential wall part 44 is set to be smaller than that of the second valve hole 47B or the third valve hole 47C.

Two second valve holes 47B are formed to be spaced apart from each other in the circumferential direction at a region on the other end side of the circumferential wall part 44 in the case axial direction (close to the other end portion of the circumferential wall part 44 in the axial direction). Two third valve holes 47C are formed to be spaced apart from each other in the circumferential direction at a region on the other end side of the circumferential wall part 44 in the case axial direction (close to the other end portion of the circumferential wall part 44 in the axial direction). The second valve holes 47B and the third valve holes 47C are formed at regions on the circumferential wall part 44 in which they substantially overlap each other in the axial direction. The second valve holes 47B and the third valve holes 47C are formed at regions on the circumferential wall part 44 in which they do not overlap the first valve hole 47A in the axial direction (regions separated in the axial direction). Shapes of the second valve hole 47B and the third valve hole 47C are arbitrary such as a perfect circular shape, an oval shape, and a rectangular shape, but a width of the third valve hole 47C, capable of communicating with the radiator outlet 60, in the axial direction of the circumferential wall part 44 is configured to be larger than that of the second valve hole 47B.

Here, the connecting wall 45 of the valve body 22 described above extends radially inward from an axially inner position of the circumferential wall part 44 with respect to an end edge of the first valve hole 47A close to one end portion in the axial direction (close to one end portion of the circumferential wall part 44 in the axial direction). In a region at which the first valve hole 47 is not present on the circumferential wall part 44, an end portion of the connecting wall 45 on an outer circumferential side is directly connected to an inner circumferential surface of the circumferential wall part 44 as illustrated in FIG. 4. In contrast, in a region at which the first valve hole 47 is present on the circumferential wall part 44, the end portion of the connecting wall 45 on the outer circumferential side is connected to an end edge 47Ae-1 close to one end portion of the first valve hole 47A via a connecting part 50 that is recessed radially inward with respect to an outer circumferential surface of the circumferential wall part 44 as illustrated in FIG. 7. The connecting part 50 extends toward an inner side of the first valve hole 47A (toward an axially inner side of the circumferential wall part 44) while being recessed radially inward in a stepped manner from the end edge 47Ae-1 close to one end portion of the first valve hole 47A of the circumferential wall part 44. The end portion of the connecting wall 45 on the outer circumferential side is connected to an end portion of the connecting part 50 in a direction in which the connecting part 50 extends.

In the valve body 22 of the present embodiment, an edge portion of the connecting wall 45 on the outer circumferential side is disposed on the axially inner side with respect to the end edge 47Ae-1 close to one end portion of the first valve hole 47A as described above, and thereby a recess-shaped part 51 that opens to one end portion side of the circumferential wall part 44 in the axial direction is formed. A depth of an outer circumferential edge portion of the recess-shaped part 51 (a depth from one end side in the axial direction of the circumferential wall part 44) is larger than that of the end edge 47Ae-1 close to one end portion of the first valve hole 47A. The bulging part 32a-1 formed on the end portion wall 32 of the casing 21 enters the inside of the recess-shaped part 51. Since the recess-shaped part 51 of the valve body 22 has a depth that is particularly large at the outer circumferential edge portion, a volume of the bulging part 32a-1 on the casing 21 side that enters the inside of the recess-shaped part 51 is large.

As illustrated in FIGS. 4 and 7, the connecting wall 45 is curved inward in the axial direction from the end portion on the radially outer side toward the radially inner side. That is, the connecting wall 45 is formed such that the cooling liquid that has flowed in from the inlet 17 of the circumferential wall part 44 on the other end side in the axial direction flows smoothly in a direction of the first valve hole 47A along a curved surface of the connecting wall 45.

Since the connecting wall 45 is a wall for connecting the circumferential wall part 44 of the valve body 22 and the drive shaft 27, it can also be formed in a spoke shape, but the connecting wall 45 of the present embodiment is formed by a continuous wall having no gap or opening to close a space between the circumferential wall part 44 and the drive shaft 27.

### [Sealing Mechanism]

Next, a structure of the sealing mechanism 36 provided at each outlet (the bypass outlet 65, the radiator outlet 60, and the air conditioning outlet 68) and a peripheral portion thereof will be described. Since the sealing mechanism 36 disposed at each outlet has the same basic structure, structures of the sealing mechanism 36 of the bypass outlet 65 and a peripheral portion thereof will be described in detail below, and structures of the sealing mechanism 36 of the radiator outlet 60, the air conditioning outlet 68, and peripheral portions thereof will be omitted.

In the following description, a direction along an axis O2 of the bypass outlet 65 (see FIG. 5) may be referred to as a port axial direction. In this case, in the port axial direction, a side toward the axis O1 (see FIG. 5) with respect to the bypass port 64 is referred to as an inner side, and a side away from the axis O1 with respect to the bypass port 64 is referred to as an outer side. A direction perpendicular to the axis O2 may be referred to as a port radial direction, and a direction around the axis O2 may be referred to as a port circumferential direction.

As illustrated in FIG. 6, the bypass outlet 65 formed in the bypass port 64 includes a small diameter hole 65a adjacent to an inner surface of the casing 21, a medium diameter hole 65b provided to be connected to the outer side of the small diameter hole 65a in the port axial direction, and a large diameter hole 65c provided to be connected to the outer side of the medium diameter hole 65b in the port axial direction.

The bypass joint 66 includes a joint cylindrical part 53 disposed coaxially with the axis O2, and a joint flange part 54 protruding outward in the port radial direction from the joint cylindrical part 53. The joint flange part 54 overlaps an end surface of the bypass port 64 in a direction in which the bypass port 64 bulges and is fixed to the bypass port 64 by bolt fastening or the like. The joint cylindrical part 53 includes a large diameter part 53a fitted in the large diameter hole 65c of the bypass outlet 65, a small diameter part 53b fitted in the medium diameter hole 65b of the bypass outlet 65, and a medium diameter part 53c that forms an annular seal accommodating part 58 between itself and the large diameter hole 65c of the bypass outlet 65.

An inner circumferential surface of the joint cylindrical part 53 includes an enlarged diameter groove 55 formed to be continuous to an inner end portion of the joint cylindrical part 53 in the port axial direction. A stepped part 55a is provided at an outer end portion of the enlarged diameter groove 55 in the port axial direction.

The sealing mechanism 36 is disposed in a portion surrounded by the bypass outlet 65 of the bypass port 64 and the bypass joint 66. The sealing mechanism 36 includes the seal cylindrical member 37, the biasing member 38, and the seal members 39 and 40. A part of the seal cylindrical member 37 is inserted into the small diameter hole 65a of the bypass outlet 65.

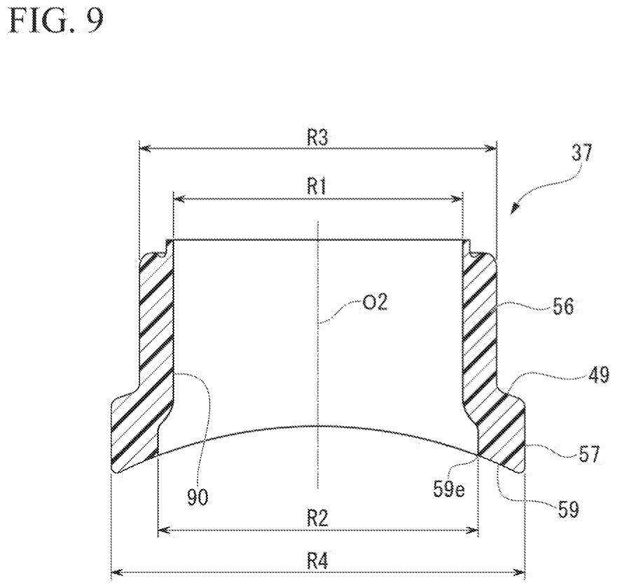

FIG. 9 is a longitudinal sectional view of the seal cylindrical member 37.

The seal cylindrical member 37 includes a circumferential wall extending coaxially with the axis O2. A circumferential wall of the seal cylindrical member 37 is formed in a multistage cylindrical shape in which an outer diameter thereof decreases in stages toward the outer side in the port axial direction. Specifically, the circumferential wall of the seal cylindrical member 37 includes a first cylindrical part 56 positioned on the outer side in the port axial direction (one end portion side in the axial direction) and configured to communicate with the downstream side of the bypass outlet 65, and a second cylindrical part 57 positioned on the inner side in the port axial direction (the other end portion side in the axial direction) and configured to have an inner diameter and an outer diameter larger than those of the first cylindrical part 56. As illustrated in FIG. 9, when it is assumed that an inner diameter of the first cylindrical part 56 is R1, an inner diameter of the second cylindrical part 57 is R2, an outer diameter of the first cylindrical part 56 is R3, and an outer diameter of the second cylindrical part 57 is R4, the inner and outer diameters of the first cylindrical part 56 and the second cylindrical part 57 are set to satisfy R1<R2 and R3<R4.

Inner circumferential surfaces of the first cylindrical part 56 and the second cylindrical part 57 form an internal passage 90 that allows an outer end (one end portion) and an inner end (the other end portion) of the seal cylindrical member 37 in the port axial direction to communicate with each other.

As illustrated in FIG. 6, the large diameter second cylindrical part 57 of the seal cylindrical member 37 is slidably inserted into an inner circumferential surface of the small diameter hole 65a of the bypass outlet 65. An inner end surface of the second cylindrical part 57 in the port axial direction constitutes an annular valve sliding contact surface 59 (sliding contact surface) that is slidably in contact with the outer circumferential surface of the circumferential wall part 44 of the valve body 22. In the present embodiment, the valve sliding contact surface 59 is a continuous curved surface that follows a shape of the outer circumferential surface of the circumferential wall part 44.

An outer circumferential surface of the first cylindrical part 56 is continuous with an outer circumferential surface of the second cylindrical part 57 via a stepped surface 49. A gap Q1 sandwiched between the stepped surface 49 of the seal cylindrical member 37 and an end surface of the small diameter part 53b of the bypass joint 66 is formed between the outer circumferential surface of the first cylindrical part 56 of the seal cylindrical member 37 and an inner circumferential surface of the medium diameter hole 65b of the bypass outlet 65. The annular seal member 39 such as an X packing or a Y packing is interposed in the gap Q1. The seal member 39 is slidably in close contact with the outer circumferential surface of the first cylindrical part 56 of the seal cylindrical member 37 and the inner circumferential surface of the medium diameter hole 65b of the bypass outlet 65.

A liquid pressure of the cooling liquid in the casing 21 is introduced into an inner space part in the port axial direction through a gap between the small diameter hole 65a of the bypass outlet 65 and the second cylindrical part 57 of the seal cylindrical member 37 with the seal member 39 in the gap Q1 interposed therebetween. The stepped surface 49 is formed in a direction opposite to the valve sliding contact surface 59 of the seal cylindrical member 37 in the port axial direction. The stepped surface 49 constitutes a pressure receiving surface that receives the liquid pressure of the cooling liquid in the casing 21 and is pressed inward in the port axial direction. The annular seal member 40 such as an O-ring is interposed to seal a space between the large diameter hole 65c of the bypass outlet 65 and the medium diameter part 53c of the bypass joint 66 in a liquid-tight manner.

The biasing member 38 is interposed between an end surface in the axial direction of the first cylindrical part 56 of the seal cylindrical member 37 and the stepped part 55a of the bypass joint 66. The biasing member 38 may be formed of, for example, a wave spring or the like. The biasing member 38 biases the seal cylindrical member 37 inward in the port axial direction (toward the circumferential wall part 44 of the valve body 22).

Here, in the seal cylindrical member 37, an area S1 of the stepped surface 49 and an area S2 of the valve sliding contact surface 59 are set to satisfy the following expressions (1) and (2).

S1<S2≤S1/k (1)

α≤k<1 (2)

k: A pressure reduction constant of the cooling liquid flowing in a minute gap between the valve sliding contact surface 59 and the circumferential wall part 44 of the valve body 22

α: A lower limit value of the pressure reduction constant determined by physical properties of the cooling liquid

The area S1 of the stepped surface 49 and the area S2 of the valve sliding contact surface 59 mean areas when these are projected in the port axial direction.

α in expression (2) is a standard value of the pressure reduction constant decided by types of cooling liquid, a usage environment (for example, temperature), or the like. For example, in a case of water under normal conditions of use, α=1/2 is satisfied. When physical properties of the cooling liquid to be used change, it changes to α=1/3 or the like.

When the valve sliding contact surface 59 is uniformly in contact with the circumferential wall part 44 from an outer end edge to an inner end edge in the port radial direction, the pressure reduction constant k in expression (2) is α (for example, 1/2) which is the standard value of the pressure reduction constant. However, a gap between an outer circumferential portion of the valve sliding contact surface 59 and the circumferential wall part 44 may be slightly increased with respect to an inner circumferential portion of the valve sliding contact surface 59 due to a manufacturing error, an assembly error, or the like of the seal cylindrical member 37. In this case, the pressure reduction constant k in expression (2) gradually approaches k=1.

In the present embodiment, a relationship between the area S1 of the stepped surface 49 and the area S2 of the valve sliding contact surface 59 is determined by expressions (1) and (2) on the premise that there is a minute gap to allow sliding between the valve sliding contact surface 59 of the seal cylindrical member 37 and the outer circumferential surface of the circumferential wall part 44.

That is, as described above, the pressure of the cooling liquid in the casing 21 acts on the stepped surface 49 of the seal cylindrical member 37 as it is. On the other hand, the pressure of the cooling liquid in the casing 21 does not act on the valve sliding contact surface 59 as it is. Specifically, the pressure of the cooling liquid acts while accompanying pressure reduction when the cooling liquid flows from the outer end edge toward the inner end edge in the port radial direction through the minute gap between the valve sliding contact surface 59 and the circumferential wall part 44. At this time, the pressure of the cooling liquid tries to push up the seal cylindrical member 37 outward in the port axial direction while the pressure of the cooling liquid gradually decreases inward in the port radial direction.

As a result, a force obtained by multiplying the area S1 of the stepped surface 49 by a pressure P in the casing 21 acts on the stepped surface 49 of the seal cylindrical member 37 as it is. On the other hand, a force obtained by multiplying the area S2 of the valve sliding contact surface 59 by the pressure P in the casing 21 and the pressure reduction constant k acts on the valve sliding contact surface 59 of the seal cylindrical member 37.

In the control valve 8 of the present embodiment, as apparent from expression (1), the areas S1 and S2 are set such that k×S2≤S1 is satisfied. Therefore, a relationship of P×k×S2≤P×S1 is also satisfied.

Therefore, a force F1 (F1=P×S1) in a pressing direction acting on the stepped surface 49 of the seal cylindrical member 37 increases to be equal to or larger than a force F2 (F2=P×k×S2) in a lifting direction acting on the valve sliding contact surface 59 of the seal cylindrical member 37. Therefore, in the control valve 8 of the present embodiment, a space between the seal cylindrical member 37 and the circumferential wall part 44 can be sealed only by the relationship of the pressure of the cooling liquid in the casing 21.

On the other hand, in the present embodiment, as described above, the area S1 of the stepped surface 49 of the seal cylindrical member 37 is smaller than the area S2 of the valve sliding contact surface 59. Therefore, even when the pressure of the cooling liquid in the casing 21 is increased, the valve sliding contact surface 59 of the seal cylindrical member 37 being pressed against the circumferential wall part 44 with an excessive force can be suppressed. Therefore, when the control valve 8 of the present embodiment is employed, a size and output of the drive unit 23 for rotationally driving the valve body 22 can be prevented from increasing, and furthermore, abrasion of the seal cylindrical member 37 and bushes of the drive unit at an early stage can be suppressed.

As described above, in the present embodiment, the area S2 of the valve sliding contact surface 59 is set to be larger than the area S1 of the stepped surface 49 in a range in which the force pressing inward in the port axial direction to act on the seal cylindrical member 37 is not lower than the force lifting outward in the port axial direction to act on the seal cylindrical member 37. Therefore, the space between the seal cylindrical member 37 and the circumferential wall part 44 can be sealed while suppressing the pressing of the seal cylindrical member 37 against the circumferential wall part 44 with an excessive force.

### [Valve Body and Seal Cylindrical Member]

The first valve hole 47A formed close to one end portion in the axial direction of the circumferential wall part 44 of the valve body 22 is formed in a long hole shape that is long in the circumferential direction of the circumferential wall part 44 as described above. The first valve hole 47A opens and closes the first seal cylindrical member 37A due to the rotational operation of the valve body 22. While the valve body 22 rotates in a state in which the first seal cylindrical member 37A is closed by the circumferential wall part 44, almost the entire surface of the valve sliding contact surface 59 of the first seal cylindrical member 37 is in contact with the outer circumferential surface of the circumferential wall part 44 and slides. While the valve body 22 rotates in a state in which the first seal cylindrical member 37A is opened by the first valve hole 47A, a part of the valve sliding contact surface 59 of the first seal cylindrical member 37 is in contact with the end edge 47Ae-1 close to one end portion in the axial direction of the first valve hole 47A and an end edge 47Ae-2 close to the other end portion thereof (an end side on a side facing the end edge 47Ae-1 close to one end portion with the first valve hole 47A sandwiched therebetween) and slides.

In the present embodiment, the end edge 47Ae-1 close to one end portion and the end edge 47Ae-2 close to the other end portion of the first valve hole 47A are set to be in contact with a radially outer position with respect to an inner circumferential end portion 59e (see FIG. 9) in the valve sliding contact surface 59 of the first seal cylindrical member 37A. That is, when the valve body 22 rotates, the end edge 47Ae-1 close to one end portion and the end edge 47Ae-2 close to the other end portion do not move at an inner position with respect to the inner circumferential end portion 59e of the valve sliding contact surface 59 (inner position with respect to an inner circumferential surface of the valve sliding contact surface 59) in the axial direction of the circumferential wall part 44.

### [Operation of Control Valve]

Next, the operation of the control valve 8 described above will be described.

As illustrated in FIG. 1, in the main flow path 10, the cooling liquid sent out by the water pump 3 is subject to heat exchange at the engine 2 and then flows toward the control valve 8. The cooling liquid that has passed through the engine 2 in the main flow path 10 flows into the casing 21 of the control valve 8 through the inlet 17.

Of the cooling liquid that has flowed into the casing 21 of the control valve 8, some of the cooling liquid flows into the EGR outlet 63. The cooling liquid that has flowed into the EGR outlet 63 is supplied into the EGR flow path 14 through the EGR joint 52. The cooling liquid that has been supplied into the EGR flow path 14 is returned to the main flow path 10 after heat exchange between the cooling liquid and an EGR gas is performed in the EGR cooler 7.

On the other hand, of the cooling liquid that has flowed into the casing 21 of the control valve 8, the cooling liquid that has not flowed into the EGR outlet 63 is distributed to each of the flow paths 11 to 13 through any of the outlets (the radiator outlet 60, the bypass outlet 65, and the air conditioning outlet 68) opened by the valve body 22 according to a rotational position of the valve body 22 in the casing 21.

In the control valve 8, in order to switch a communication pattern between the valve holes and the outlets, the valve body 22 is rotated around the axis O1 by the drive unit 23. Then, when rotation of the valve body 22 is stopped at a position corresponding to a communication pattern desired to be set, the valve hole and the outlet communicate with each other by the communication pattern corresponding to the stopped position of the valve body 22.

### [Effects of Embodiment]

As described above, the control valve 8 of the present embodiment has a structure in which the connecting wall 45 of the valve body 22 extends radially inward from an axially inner position of the circumferential wall part 44 with respect to the end edge 47Ae-1 close to one end portion of the first valve hole 47A, and the recess-shaped part 51 having a large depth at a radially outer region is formed on one end side of the circumferential wall part 44 in the axial direction. Then, the bulging part 32a-1 of the end portion wall 32 of the casing 21 enters the inside of the recess-shaped part 51. Therefore, when the control valve 8 of the present embodiment is employed, an inflow volume of the cooling liquid flowing into the circumferential wall part 44 of the valve body 22 by the end portion wall 32 of the casing 21 can be reduced, and each part of the liquid distribution system 1 can be quickly controlled to have a desired temperature. As a result, friction of the engine 2 serving as a drive source can be reduced.

In the control valve 8 of the present embodiment, the end portion on the radially outer side of the connecting wall 45 of the valve body 22 is connected to the end edge 47Ae-1 close to one end portion of the first valve hole 47A via the connecting part 50 that is recessed radially inward with respect to the outer circumferential surface of the circumferential wall part 44. Therefore, the connecting wall 45 is connected to the circumferential wall part 44 not only at a region in which the first valve hole 47A is not opened but also at a region in which the first valve hole 47A is opened. Therefore, when the present configuration is employed, rigidity of a joint part of the connecting wall 45 with respect to the circumferential wall part 44 of the valve body 22 can be increased.

Further, the control valve 8 of the present embodiment has a configuration in which the end edge 47Ae-1 close to one end portion of the first valve hole 47A and the end edge 47Ae-2 close to the other end portion thereof in the circumferential wall part 44 are in contact with a radially outer position with respect to the inner circumferential end portion 59e of the valve sliding contact surface 59 of the first seal cylindrical member 37A. Particularly, the end edge 47Ae-1 close to one end portion of the first valve hole 47A in the circumferential wall part 44 is connected to the connecting wall 45 via the connecting part 50 that is recessed radially inward with respect to the outer circumferential surface of the circumferential wall part 44. Therefore, the end edge 47Ae-1 close to one end portion of the first valve hole 47A can be brought into contact with a radially outer position with respect to the inner circumferential end portion 59e in the valve sliding contact surface 59 of the first seal cylindrical member 37A while securing the recess-shaped part 51 having a large depth at a radially outer region on one end side of the circumferential wall part 44 in the axial direction. Therefore, according to the above-described configuration, even when abrasion occurs on the valve sliding contact surface 59 of the first seal cylindrical member 37A due to use over time, the abraded portion does not stretch across the inner circumferential end portion 59e of the first seal cylindrical member 37A. Therefore, when the valve sliding contact surface 59 is abraded, leakage of the liquid into the first seal cylindrical member 37A through a gap between the outer circumferential surface of the circumferential wall part 44 and the valve sliding contact surface 59 can be suppressed. Therefore, when the present configuration is employed, a service life of the seal of the first seal cylindrical member 37A can be prolonged.

The control valve 8 of the present embodiment has a structure in which the connecting wall 45 of the valve body 22 closes the space between the circumferential wall part 44 and the drive shaft 27, and the cooling liquid that has flowed into the circumferential wall part 44 does not easily flow out to the outside of the connecting wall 45. Therefore, when the control valve 8 of the present embodiment is employed, the cooling liquid does not easily flow to an unnecessary portion, and a pressure loss of the cooling liquid flowing through the control valve 8 can be further reduced.

In the control valve 8 of the present embodiment, since the connecting wall 45 of the valve body 22 is curved inward in the axial direction of the circumferential wall part 44 from the end portion on the radially outer side toward the inner side, the cooling liquid that has flowed into the circumferential wall part 44 from the inlet 17 can be allowed to smoothly flow in a direction of the first valve hole 47A along the curved surface of the connecting wall 45.

Further, in the control valve 8 of the present embodiment, since the first valve hole 47A of the valve body 22 is formed in a long hole shape extending in the circumferential direction of the circumferential wall part 44, even when a part of the first valve hole 47A is narrowed by the connecting wall 45, a sufficient area of the inflow portion of the cooling liquid can be secured by the long hole shape extending in the circumferential direction.

The present invention is not limited to the embodiment described above, and various modifications can be made in design in a range without departing from the gist of the present invention. For example, the seal cylindrical member 37 employs a stepped cylindrical shape having the first cylindrical part 56 and the second cylindrical part 57 in the above-described embodiment, but the seal cylindrical member 37 may have a cylindrical shape without a stepped part.

However, when the seal cylindrical member 37 has the stepped cylindrical shape having the first cylindrical part 56 and the second cylindrical part 57 as in the above-described embodiment, a sufficient amount of cooling liquid can be allowed to flow out to a corresponding outlet even if the valve hole in the valve body 22 side that opens and closes the seal cylindrical member 37 does not have a long hole shape extending in the circumferential direction.

That is, a pressure loss of the cooling liquid flowing through the seal cylindrical member 37 is affected only by an opening area of the first cylindrical part 56 having an inner diameter smaller than that of the second cylindrical part 57. Therefore, even when the valve hole formed on one end side in the axial direction of the circumferential wall part 44 of the valve body 22 does not have a long hole shape, and moreover, a part of the valve hole is narrowed by the connecting wall 32, if the opening area of the valve hole is larger than the opening area of the internal passage of the first cylindrical part 56 of the seal cylindrical member 37, a sufficient amount of cooling liquid can be allowed to flow out to a corresponding outlet regardless of the opening area on the valve hole side. In this case, the connecting wall 32 can be disposed to be offset in a direction toward the inside of the valve hole (to the inside in the case axial direction) while suppressing a decrease in flow rate of the cooling liquid flowing out from the outlet.

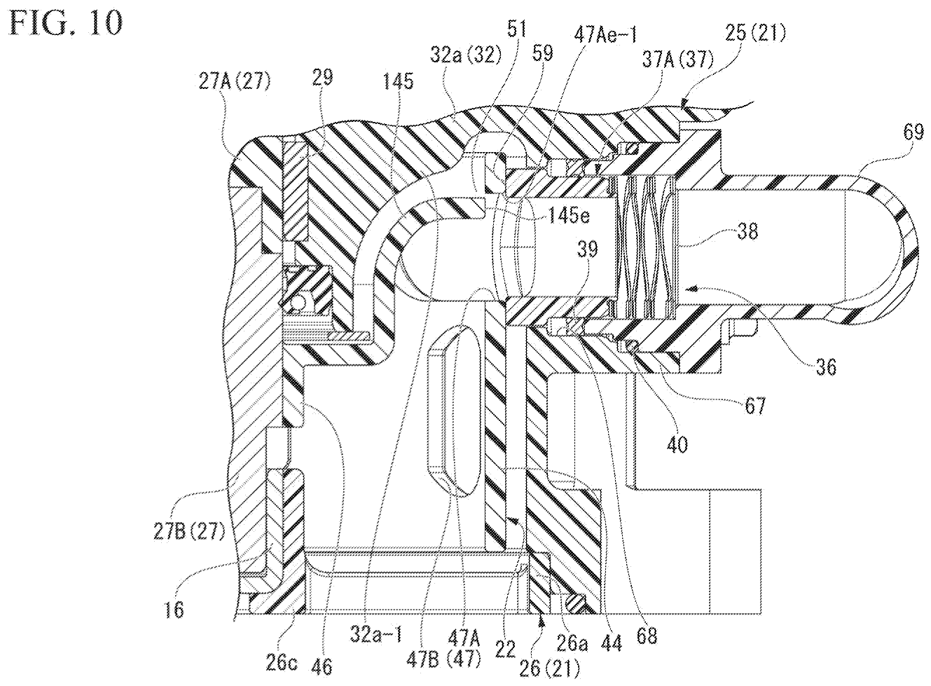

In the above-described embodiment, the end portion on the radially outer side of the connecting wall 45 of the valve body 22 is connected to the end edge 47Ae-1 close to one end portion of the first valve hole 47A via the connecting part 50. However, as illustrated in FIG. 10, the end portion on the radially outer side of the connecting wall 45 may not be connected to the end edge 47Ae-1 of the first valve hole 47A as long as it extends radially inward from an axially inner position with respect to the end edge 47Ae-1 close to one end portion of the first valve hole 47A. In FIG. 10, portions common to those in the above-described embodiment are denoted by the same reference signs.

In the above-described embodiment, the valve body 22 has the cylindrical circumferential wall part 44, and the valve holes 47 for opening and closing the outlets of the seal cylindrical member 37 are formed on the outer circumferential surface of the cylindrical circumferential wall part 44. However, a shape of the circumferential wall part 44 of the valve body 22 is not limited to the cylindrical shape in which a diameter of the outer circumferential surface is constant in the axial direction. That is, a shape of the circumferential wall part 44 of the valve body 22 may be such that a diameter of the outer circumferential surface changes in the axial direction. In this case, the circumferential wall part 44 of the valve body 22 can employ various shapes such as, for example, a spherical shape (a shape whose diameter decreases from a center in the axial direction toward opposite end portions) or a shape in which a plurality of spherical shapes are continuous in the axial direction, a tapered shape (a shape in which a diameter gradually changes from a first side to a second side in the axial direction), a stepped shaped (a shape in which a diameter changes in a staircase manner from the first side to the second side in the axial direction), or the like.

What is claimed is:

1. A control valve comprising:
a casing including an inlet into which a liquid flows from the outside and an outlet through which the liquid that has flowed into the inside is allowed to flow out to the outside;
a valve body rotatably disposed inside the casing and including a valve hole formed close to one end portion of a circumferential wall part in an axial direction;
a seal cylindrical member including one end portion which communicates with the outlet and the other end portion which is in contact with an outer circumferential surface of the circumferential wall part to be opened and closed by the valve hole; and
a drive shaft disposed at an axial center position of the valve body and configured to transmit rotational power to the valve body, wherein
the valve body includes the circumferential wall part and a connecting wall which connects a position close to the one end portion of the circumferential wall part in the axial direction and the drive shaft,
the connecting wall extends radially inward from an axially inner position of the circumferential wall part with respect to an end edge close to the one end portion of the valve hole to form a recess-shaped part that opens to the one end portion side of the circumferential wall part in the axial direction, and
an end portion wall on one end portion side of the casing in the axial direction bulges to enter the inside of the recess-shaped part.

2. The control valve according to claim 1, wherein an end portion on a radially outer side of the connecting wall is connected to the end edge close to the one end portion of the valve hole via a connecting part that is recessed radially inward with respect to the outer circumferential surface of the circumferential wall part.

3. The control valve according to claim 2, wherein
the seal cylindrical member includes an annular valve sliding contact surface that is slidably in contact with the outer circumferential surface of the circumferential wall part, and
the end edge close to the one end portion of the valve hole and an end edge close to the other end portion facing the end edge are in contact with a radially outer position with respect to an inner circumferential end portion of the valve sliding contact surface of the seal cylindrical member.

4. The control valve according to claim 1, wherein the connecting wall closes a space between the circumferential wall part and the drive shaft.

5. The control valve according to claim 4, wherein the connecting wall is curved inward in the axial direction of the circumferential wall part from the end portion on the radially outer side toward the radially inner side.

6. The control valve according to claim 1, wherein the valve hole is formed in a long hole shape extending in a circumferential direction of the circumferential wall part.
